(19) United States
(12) Patent Application Publication
(10) Pub. No.: US 2025/0049273 A1
(43) Pub. Date: Feb. 13, 2025

(54) WINDOW CLEANING ROBOT

(71) Applicant: SHENZHEN ONEJ TECHNOLOGY CO., LTD, Shenzhen (CN)

(72) Inventors: LI-GUO DING, Shenzhen (CN); MING GAO, Shenzhen (CN)

(73) Assignee: SHENZHEN ONEJ TECHNOLOGY CO., LTD, Shenzhen (CN)

(21) Appl. No.: 18/795,062

(22) Filed: Aug. 5, 2024

(30) Foreign Application Priority Data
Aug. 8, 2023 (CN) 202322118167.5
Apr. 16, 2024 (CN) 202410457978.4

(51) Int. Cl. A47L 1/02; B08B 1/14; B08B 1/30; B08B 1/40; B25J 11/00

(52) U.S. Cl. CPC A47L 1/02; B08B 1/143; B08B 1/30; B08B 1/40; B25J 11/0085

(57) ABSTRACT

A window cleaning robot includes a main body including a top shell and a bottom shell. The top shell and the bottom shell define an internal space of the main body and the bottom shell includes a plurality of air inlets. At least two driving mechanisms are disposed between the two driving mechanisms. An air pump is disposed in the internal space and configured to extract air, through the inlets of the bottom shell, between the two driving mechanisms to create negative pressure to form a vacuum area located between the two driving mechanisms. An accommodating portion is configured to accommodate the air pump and an air tube, disposed in the internal space, includes an air inlet end coupled to an opening of the accommodating portion and an air outlet end coupled to an air exhaust opening toward the driving mechanism. The air inlet end of the air tube is configured to receive the extracted air and the extracted air is then exhausted toward the driving mechanism via the air tube and the air exhaust opening.

### FIELD

The subject matter herein generally relates to a window cleaning robot, especially a window cleaning robot with exhausting air toward driving mechanism of the window cleaning robot.

### BACKGROUND

The current window cleaning robot exhausts air through the air exhaust port on the side of the main body of the window cleaning robot, which generates a lot of noise. When the window cleaning robot moves, the driving mechanism of the window cleaning robot runs over the cleaning water sprayed on the glass plate and the driving mechanism of the window cleaning robot is not able to keep dry. Therefore, the skid probability of driving mechanism of the window cleaning robot is then increased.

### SUMMARY

The purpose of the present disclosure is to provide a window cleaning robot.

To achieve the above purpose, the current disclosure discloses a window cleaning robot. The window cleaning robot includes a main body including a top shell and a bottom shell. The top shell and the bottom shell define an internal space of the main body and the bottom shell includes a plurality of air inlets.

At least two driving mechanisms are disposed between the two driving mechanisms. An air pump is disposed in the internal space and configured to extract air, through the inlets of the bottom shell, between the two driving mechanisms to create negative pressure to form a vacuum area located between the two driving mechanisms.

An accommodating portion is configured to accommodate the air pump and an air tube, disposed in the internal space, includes an air inlet end coupled to an opening of the accommodating portion and an air outlet end coupled to an air exhaust opening toward the driving mechanism. The air inlet end of the air tube is configured to receive the extracted air and the extracted air is then exhausted toward the driving mechanism via the air tube and the air exhaust opening.

It should be understood that the description in the section is not intended to identify key or important features of embodiments of the present disclosure, nor is it intended to limit the scope of the present disclosure. Other features of the present disclosure will be readily understood from the following specification.

### BRIEF DESCRIPTION OF THE DRAWINGS

In the accompanying drawings, unless otherwise specified, the same reference numerals throughout multiple accompanying drawings indicate the same or similar parts or elements. These accompanying drawings are not necessarily drawn to scale. It should be understood that these accompanying drawings depict only some embodiments disclosed in accordance with the present disclosure and should not be considered as limiting the scope of the present disclosure.

FIG. 1 is a schematic view of a window cleaning robot of one embodiment of the present disclosure;

FIG. 2A is a bottom view of the window cleaning robot of FIG. 1;

FIG. 2B is a schematic view of operation of the window cleaning robot of FIG. 1;

FIG. 3 is an explorer view of the window cleaning robot of FIG. 1; and

FIG. 4 is another explorer view of a window cleaning robot of one embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasable connected.

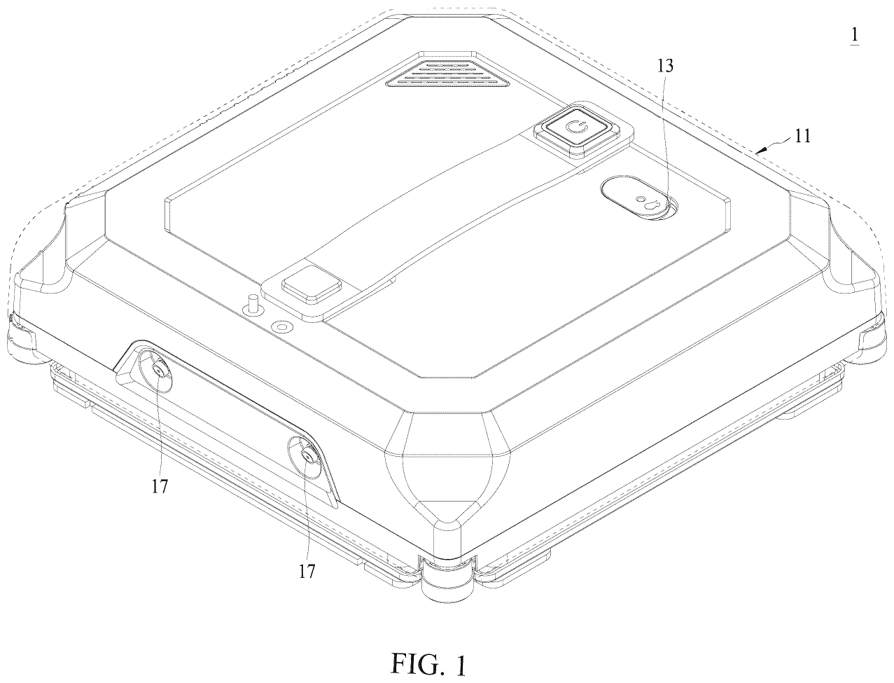

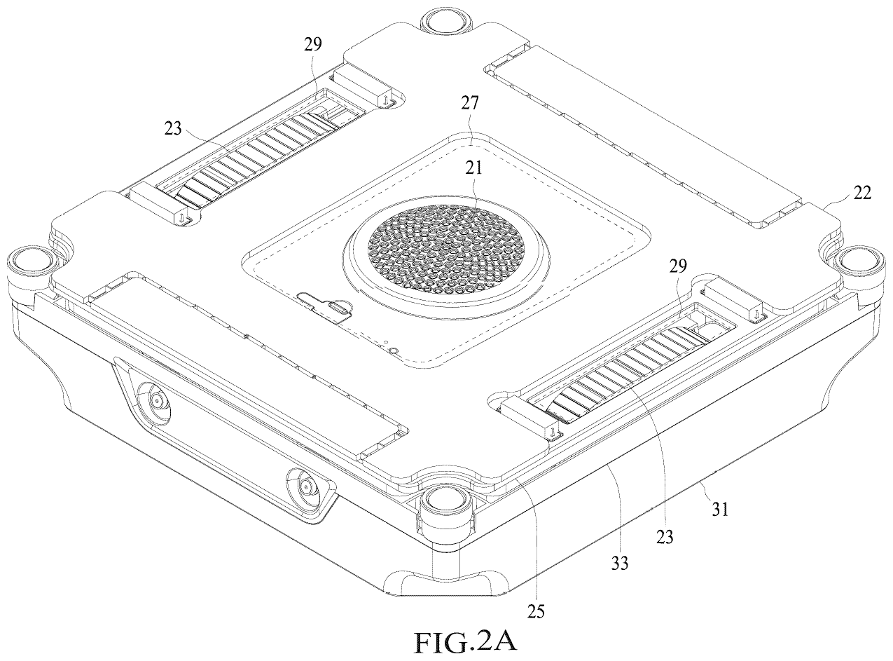

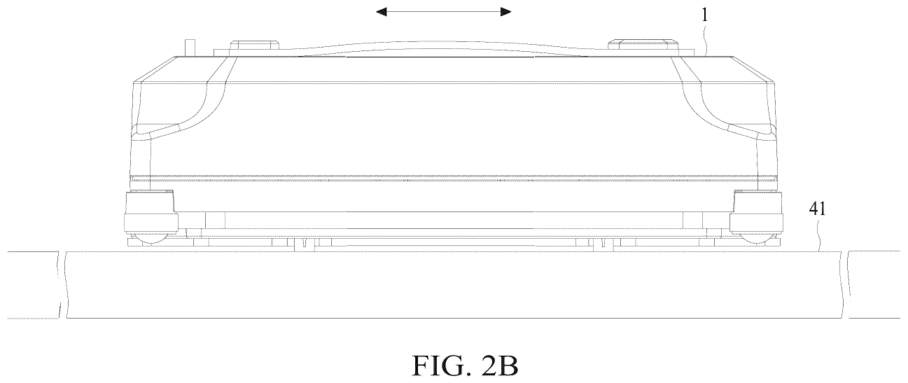

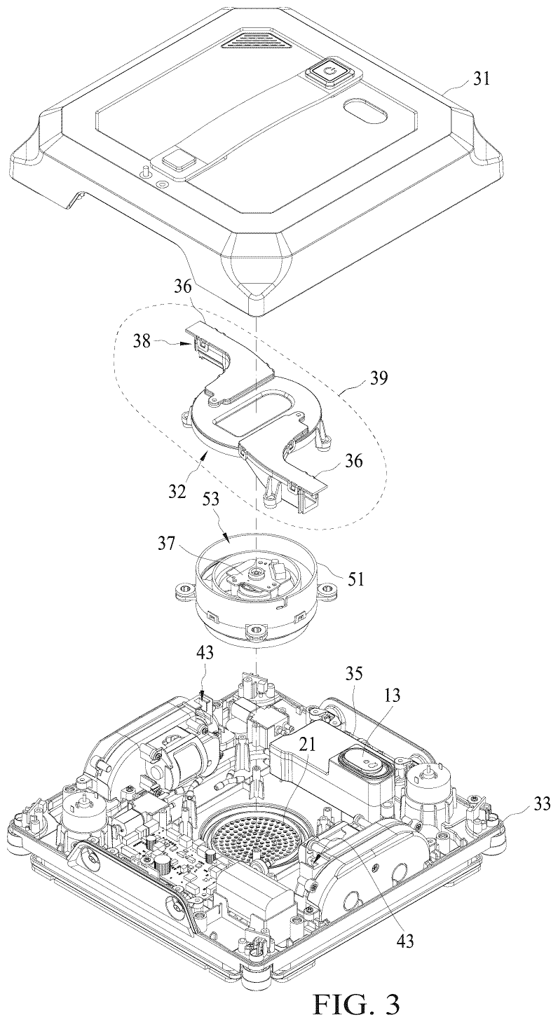

FIG. 1 is a schematic view of a window cleaning robot 1 of one embodiment of the present disclosure. FIG. 2A is a bottom view of the window cleaning robot 1 of FIG. 1. FIG. 3 is an explorer view of the window cleaning robot 1 of FIG. 1.

As shown in FIGS. 1 to 3, the window cleaning robot 1 includes a main body 11. The main body 11 includes a top shell 31 and a bottom shell 33. An internal space of the main body 11 is defined by the top shell 31 and the bottom shell 33. A water stopper 13 is plug into a water filling hole of a water tank 35 and is exposure from a opening of the top shell 31.

The user is able to fill water into the water tank 35 via the water filling hole. The water stopper 13 is configured to prevent water in the water tank 35 from flowing out to the outside of the water tank 35 through the water filling hole. The water tank 35 is configured to provide cleaning water when the window cleaning robot 1 performs cleaning work, and sprays the cleaning water through the water spray head 17.

As shown in FIG. 2A, the bottom shell 33 of the main body 11 includes a plurality of air inlets 21. In this embodiment, at least two driving mechanisms 23 are arranged in parallel. A plurality of air inlets 21 are located between the two driving mechanisms 23. In this embodiment, the driving mechanism 23 includes a caterpillar mechanism. A floating plate 25 is coupled to the bottom shell 33. The floating plate 25 includes an opening 27 for exposure a plurality of air inlets 25 and at least two driving mechanism relief holes 29.

The window cleaning robot 1 further includes a cleaning member 22 detachably fixed on the floating plate 25. In this embodiment, the cleaning member 22 includes a sheet fabric. As shown in FIG. 2B, when the window cleaning robot 1 performs cleaning work, the cleaning member 22 is configured to remove particles on a plate 41 in contact with the cleaning member 22. In this embodiment, the plate 41 includes a glass plate.

As shown in FIG. 3, an air pump 37 is disposed in the internal space and configured to extract air, through the inlets 21 of the bottom shell 33, between the two driving mechanisms 23 to create negative pressure to form a vacuum area located between the two driving mechanisms 23. Therefore, the window clean robot 1 is attached on the glass plate 41 shown in FIG. 2B. In this embodiment, an accommodating portion 51 is configured to accommodate the air pump 37.

As shown in FIG. 3 in this embodiment, an air tube 39, disposed in the internal space, including an air inlet end 32 coupled to an opening 53 of the accommodating portion 51 and an air outlet end 36 coupled to an air exhaust opening 38 toward the driving mechanism 23. Therefore, the air inlet end 32 of the air tube 39 is configured to receive the extracted air and the extracted air is then exhausted toward the driving mechanism 23 via the air tube 39 and the air exhaust opening 38.

In this embodiment, an inner wall of the accommodating portion 51 surrounds the air inlets 21 of the bottom shell 33 of the window cleaning robot 1 and an inner wall of the accommodating portion 51, close to the air inlets 21, is formed an air guide wall in a way toward the air inlets 21. In one embodiment, the accommodating portion 51 includes a cylindrical accommodating portion. In this embodiment, the extracted air is then exhausted toward the driving mechanism 23 via the air tube and the air exhaust opening 38.

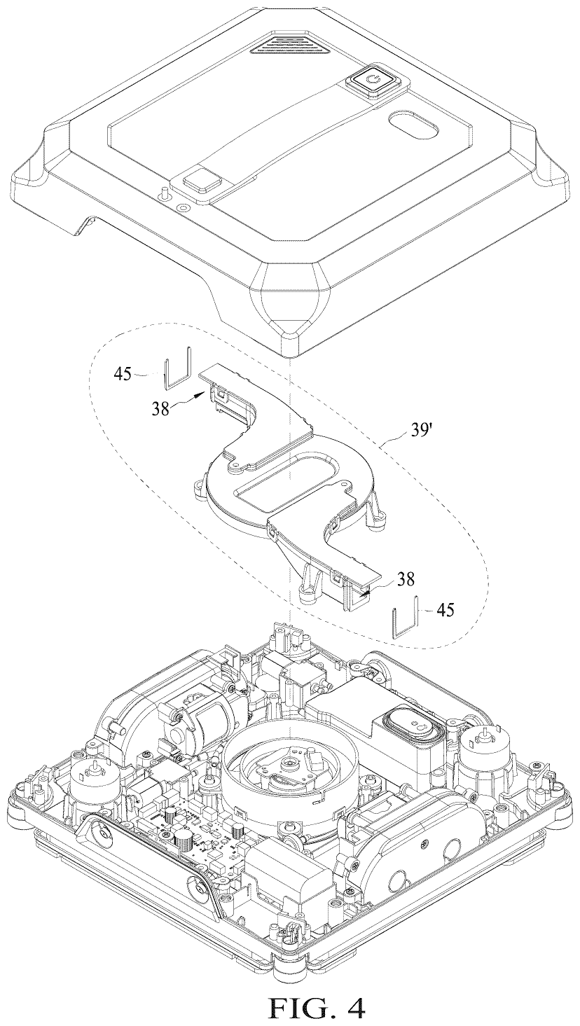

FIG. 4 is another explorer view of a window cleaning robot of one embodiment of the present disclosure. As shown in FIG. 4, in this embodiment, a sealing foam 45 is located between the air exhaust opening 38 and an opening of the bottom shell 43. The sealing foam 45 is configured to prevent leakage of the extracted air.

In summary, the plurality of inlets 21, the air pump 37, the air tube 39 and the exhaust opening 38 are formed an air exhausting path. Moreover, the extracted air is exhausted toward the driving mechanism 23 via the exhaust opening 38. Since the exhaust air is exhausted under the bottom shell 33, the exhaust noise is the reduced.

Furthermore, when the window cleaning robot 1 performs cleaning works for removing particles on the plate 41, the cleaning water is sprayed out at the same time. The driving mechanism 23 may skid on the plate 41, when the driving mechanism 23 runs over the clean water sprayed on the plate 41.

Therefore, with the air exhausting path disclosed in the present disclosure, the extracted air is exhausted toward the driving mechanism 23 to blow away the cleaning water on the driving mechanism 23. The driving mechanism 23 is then remained dry and the skid probability of the driving mechanism 23 is reduced.

The embodiments shown and described above are only examples and do not limit the patent scope of the disclosure. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A window cleaning robot, comprising:
a main body including a top shell and a bottom shell, wherein the top shell and the bottom shell define an internal space of the main body and the bottom shell includes a plurality of air inlets;
at least two driving mechanisms, wherein the air inlets are disposed between the two driving mechanisms;
an air pump disposed in the internal space and configured to extract air, through the inlets of the bottom shell, between the two driving mechanisms to create negative pressure to form a vacuum area located between the two driving mechanisms;
an accommodating portion configured to accommodate the air pump; and
an air tube, disposed in the internal space, including an air inlet end coupled to an opening of the accommodating portion and an air outlet end coupled to an air exhaust opening toward the driving mechanism;
wherein the air inlet end of the air tube is configured to receive the extracted air and the extracted air is then exhausted toward the driving mechanism via the air tube and the air exhaust opening.

2. The window cleaning robot of claim 1, wherein the driving mechanism includes a caterpillar mechanism.

3. The window cleaning robot of claim 1, wherein the bottom shell is coupled to a floating plate and the floating plate includes an opening to exposure the air inlets and at least two driving mechanism relief holes.

4. The window cleaning robot of claim 1, wherein the window cleaning robot further includes a water tank.

5. The window cleaning robot of claim 1, wherein the accommodating portion includes a cylindrical accommodating portion.

6. The window cleaning robot of claim 1, wherein an inner wall of the cylindrical accommodating portion surrounds the air inlets of the bottom shell of the window cleaning robot.

7. The window cleaning robot of claim 1, wherein an inner wall of the accommodating portion, close to the air inlets, is formed an air guide wall in a way toward the air inlets.

8. The window cleaning robot of claim 1, wherein the extracted air is exhausted, via the air exhaust opening and an opening of the bottom shell, toward the driving mechanism, wherein a sealing foam is located between the air exhaust opening and the opening of the bottom shell.

9. The window cleaning robot of claim 3, wherein the window cleaning robot further includes a cleaning member detachably fixed on the floating plate.

10. The window cleaning robot of claim 1, wherein the two driving mechanisms are arranged in parallel.
